(19) United States
(12) Patent Application Publication
(10) Pub. No.: US 2023/0256749 A1
(43) Pub. Date: Aug. 17, 2023

(54) DROSS EXTRACTION SYSTEM FOR AN MHD PRINTER AND METHODS THEREOF

(71) Applicant: XEROX CORPORATION, NORWALK, CT (US)

(72) Inventors: Joseph C. SHEFLIN, Macedon, NY (US); Chu-Heng LIU, Penfield, NY (US); Paul J. McCONVILLE, Webster, NY (US); Joshua S. HILTON, Rochester, NY (US); Kareem TAWIL, Rochester, NY (US); Brian M. BALTHASAR, North Tonawanda, NY (US); Christopher T. CHUNGBIN, Rochester, NY (US)

(73) Assignee: XEROX CORPORATION, NORWALK, CT (US)

(21) Appl. No.: 17/651,248

(22) Filed: Feb. 16, 2022

(51) Int. Cl. B41J 2/175

(52) U.S. Cl. CPC B41J 2/17563

(57) ABSTRACT

A dross extraction system for a printer is disclosed. The dross extraction system includes an ejector defining an inner cavity associated therewith, the inner cavity retaining a liquid printing material. The dross extraction system also includes an inlet coupled to the inner cavity and a conduit external to the ejector having a distal opening, positionable to contact the liquid printing material to attract dross therein, thereby extracting dross from the liquid printing material when a negative pressure is introduced between an internal volume of the conduit and the dross.

### TECHNICAL FIELD

The present teachings relate generally to liquid ejectors in drop-on-demand (DOD) printing and, more particularly, to a dross extraction system and methods for use within a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop drop-on-demand (DOD), particularly one that prints a metal or metal alloy, ejects a small drop of liquid aluminum alloy when a firing pulse is applied. Using this technology, a 3D part can be created from aluminum or another alloy by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer to form a 3D metallic object. Magnetohydrodynamic refers to the study of the magnetic properties and the behavior of electrically conducting fluids.

In MHD printing, a liquid metal is jetted out through a nozzle of the 3D printer onto a substrate or onto a previously deposited layer of metal. A printhead used in such a printer is a single-nozzle head and includes several internal components within the head which may need periodic replacement. In some instances, a typical period for nozzle replacement may be an 8-hour interval. During the liquid metal printing process, the aluminum and alloys, and in particular, magnesium containing alloys, can form oxides and silicates during the melting process in the interior of the pump. These oxides and silicates are commonly referred to as dross. The buildup of dross is a function of pump throughput and builds continuously during the print process. In addition to being composed of a combination of aluminum and magnesium oxides and silicates, the dross may also include gas bubbles. Consequently, the density of the dross may be lower than that of the liquid metal printing material and builds at the top of the melt pool, eventually causing issues during printing. In addition, dross accumulation impacts the ability of internal level-sensing that measures the molten metal level of the pump. This can cause the pump to erroneously empty during printing, thereby ruining the part. Dross plugs may also grow within the pump causing issues with the pump dynamics resulting in poor jet quality and additional print defects, such as the formation of satellite drops during printing. The dross could potentially break apart and a chunk of this oxide falls into the nozzle resulting in a clogged nozzle. All of the aforementioned failures arising from dross accumulation are catastrophic, leading to printer shut down, requiring clearing or removal of the dross plug, replacing the print nozzle, and beginning start-up procedures again.

Thus, a method of and apparatus for removal or extraction of dross in a metal jet printing drop-on-demand or 3D printer is needed to provide longer printing times and higher throughput without interruption from defects or disadvantages associated with dross build-up.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A dross extraction system for a printer is disclosed. The dross extraction system also includes an ejector defining an inner cavity associated therewith, the inner cavity retaining a liquid printing material. The dross extraction system for a printer also includes an inlet coupled to the inner cavity. The dross extraction system for a printer also includes a conduit external to the ejector having a distal opening, positionable to contact the liquid printing material to attract dross therein, thereby extracting dross from the liquid printing material when a negative pressure is introduced between an internal volume of the conduit and the dross.

The dross extraction system for a printer may include where the conduit further has a filter disposed in an internal volume of the conduit and positioned away from the distal opening of the conduit, where a space between the filter and the distal opening of the conduit is configured to hold a volume of dross. The filter may include a temperature resistant material. The conduit further may include a temperature resistant material. The conduit further may include an internal piston, where when the internal piston translates along a length of the conduit, the internal volume of the conduit is subjected to a change in pressure. The internal piston creates suction within an internal volume of the conduit when the piston is translated away from the distal opening. The conduit further may include an internal compressible member, where an internal volume is subjected to a change in pressure when the internal compressible member changes from a compressed state to an uncompressed state. The conduit further may include an internal compressible member, where an internal volume is subjected to a change in pressure when the internal compressible member changes from an uncompressed state to a compressed state. The dross extraction system includes no vacuum source or valve. The dross extraction system for a printer may include a cooling element disposed on an outer portion of the conduit.

A printer is also disclosed. The printer includes an ejector defining an inner cavity associated therewith, the inner cavity retaining a liquid printing material. The printer also includes a first inlet coupled to the inner cavity. The printer also includes a dross extraction system, may include a conduit external to the ejector, where the conduit may include a distal opening and is configured to contact the liquid printing material to attract dross therein, is configured to be advanced into and retracted out from the inner cavity of the ejector. The printer also includes a filter disposed in an internal volume of the conduit and positioned away from the distal opening of the conduit, where a space between the filter and the distal opening of the conduit is configured to hold a volume of dross.

The printer may include where the conduit further may include an internal piston, where the internal piston translates along a length of the conduit when the internal volume of the conduit is subjected to a change in pressure; and the internal piston creates suction within an internal volume of the conduit when the piston is translated away from the distal opening. The printer may include a motor configured to control a position of the internal piston along the length of the conduit. The conduit further may include an internal compressible member, where an internal volume is subjected to a change in pressure when the internal compressible member changes from a compressed state to an uncompressed state; and an internal volume is subjected to a change in pressure when the internal compressible member changes from an uncompressed state to a compressed state. The printer may include a motor configured to control a compression state of the internal compressible member. The internal volume of the conduit only has an open connection to an external environment via the distal opening.

A method of extracting dross from a metal jetting printer is disclosed. The method of extracting dross includes pausing an operation of the metal jetting printer. The method of extracting dross also includes advancing a conduit having an internal member and a distal opening into a melt pool within a nozzle pump reservoir in the metal jetting printer, the melt pool may include a metal printing material. The method of extracting dross also includes creating suction within the conduit by increasing an internal volume of the conduit in a space between the internal member and the distal opening. The method of extracting dross also includes extracting dross from a surface of the metal printing material and into the conduit. The method of extracting dross also includes retracting the conduit including the dross from the nozzle pump reservoir. The method of extracting dross may include resuming the operation of the metal jetting printer. Implementations of the method of extracting dross may include where the internal member includes a piston. The internal member includes a compressible member. Implementations of the described techniques may include hardware, a method or process, or computer software on a computer-accessible medium.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid ejector jet of a 3D printer (e.g., a MHD printer and/or multi-jet printer), in accordance with the present disclosure.

FIG. 2 is a side cross-sectional views of a liquid ejector jet contaminated with dross, in accordance with the present disclosure.

FIG. 3 is a schematic view of an end of a dross extraction device, in accordance with the present disclosure.

FIGS. 4A-4D are a series of side cross-sectional views of a single liquid ejector jet having a dross extraction system, illustrating operative steps of the dross extraction system, in accordance with the present disclosure.

FIG. 5 is a flowchart illustrating a method of extracting dross in a metal jetting printer, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary examples of the present teachings, examples of which are illustrated in the accompanying drawings. Wherever possible, the same reference numbers will be used throughout the drawings to refer to the same, similar, or like parts.

In drop-on-demand (DOD), metal-jetting printing, or three-dimensional (3D) printing, a small drop of liquid aluminum or other metal or metal alloy are ejected when a firing pulse is applied. Using this printing technology, a 3D part can be created from aluminum or another alloy by ejecting a series of drops which bond together to form a continuous part. During a typical printing operation, the raw printing material wire feed can be replenished to the pump inside an ejector using a continuous roll of aluminum wire. The wire printing material may be fed into the pump using standard welding wire feed equipment or other means of introduction, such as a powder feed system. As printing occurs and new material is fed into the pump, a contaminant known as dross may accumulate in the top of the upper pump of the ejector. This build-up of dross is a function of the total throughput of printing material through the pump and ejector. As the dross contamination builds within the pump and/or ejector it eventually results in defects such as degraded jetting performance, nozzle or machine contamination, level sensor faults, additional printer maintenance, shut down, or contamination related catastrophic failure. While systems exist to counteract dross accumulation in similar ejector and printer systems, they are fairly complex and require manual operations involving multiple operators.

In examples as described herein, a dross extraction system having a conduit or tube is lowered into an inner cavity of the ejector via an inlet, and then into dross floating at the top of the molten aluminum melt pool in the jetting crucible or pump portion of the ejector in a printing system having a metal jetting liquid ejector. The conduit includes a distal opening that is configured to contact the surface of the liquid printing material and to attract dross therein. The conduit may be automatically or manually advanced into and retracted out from the inner cavity of the ejector to extract the dross from a surface of the melt pool. The conduit or dross extraction tube further includes a filter disposed in an internal volume of the conduit and positioned away from the distal opening of the conduit to prevent the dross from traveling too far up into the conduit. A space between the filter and the distal opening of the conduit holds a volume of dross which can be removed from the ejector. As the dross extraction system is airtight and sealed, the dross or other contamination in the ejector may be suctioned into the opening of the conduit by creation of suction, or by creation of a negative pressure within the conduit by translation or transformation of a piston-like element, a compressible element, or the like. The mechanism of the creation of suction does not involve a vacuum device or a valve-operated device or mechanism. As there is no other outlet for the air volume within the conduit to escape other than internal to the conduit, and thus as a piston or other member creates an increasing volume within the conduit, that volume increase results in a negative pressure or suction within the conduit. In certain aspects, the conduit or tube-based extraction system may be disposable and replaced between cleaning cycles. In other aspects, the extraction system may be cleaned and re-used. The extraction system may be inserted and withdrawn or retracted manually, or in an automated, mechanical fashion. The material of the extraction system would not interfere with the electrical pulses used to jet the aluminum, so it could optionally be used during the jetting cycle, and without disrupting a printing operation.

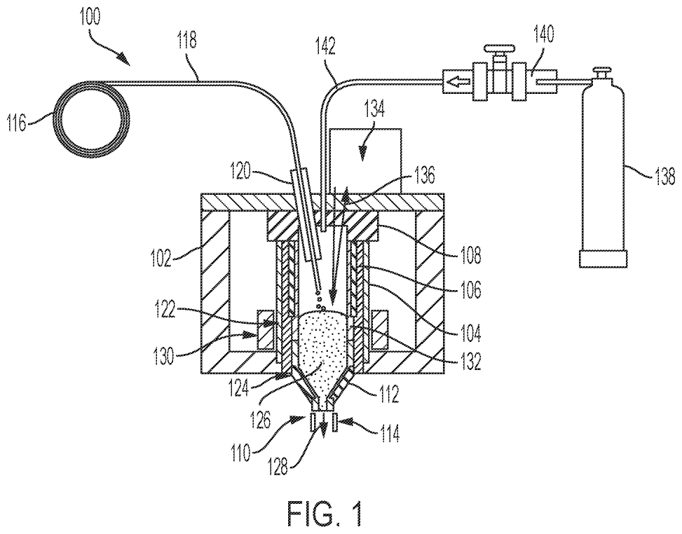

FIG. 1 depicts a schematic cross-sectional view of a single liquid ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity). A printing material 126 may be introduced into the inner volume 132 of the ejector 104. The printing material 126 may be or include a metal, a polymer, or the like. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, also referred to as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate, not shown herein, that is positioned proximate to (e.g., below) the nozzle 110. The ejected drops 128 may land on the substrate and solidify to produce a 3D object. The 3D printer 100 may also include a substrate control motor that is configured to move the substrate while the drops 128 are being jetted through the nozzle 110, or during pauses between when the drops 128 are being jetted through the nozzle 110, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate may be moved under a stationary nozzle 110, or the nozzle 110 may be moved above a stationary substrate. In yet another example, there may be relative rotation between the nozzle 110 and the substrate around one or two additional axes, such that there is four or five axis position control. In certain examples, both the nozzle 110 and the substrate may move. For example, the substrate may move in X and Y directions, while the nozzle 110 moves up and/or down in a Y direction.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate, additional system elements, or a combination thereof may be positioned at least partially within the enclosure 102. In another example, the ejector 104, the heating elements 112, the power source, the coils, the substrate, additional system elements, or a combination thereof may be positioned at least partially outside of the enclosure 102.

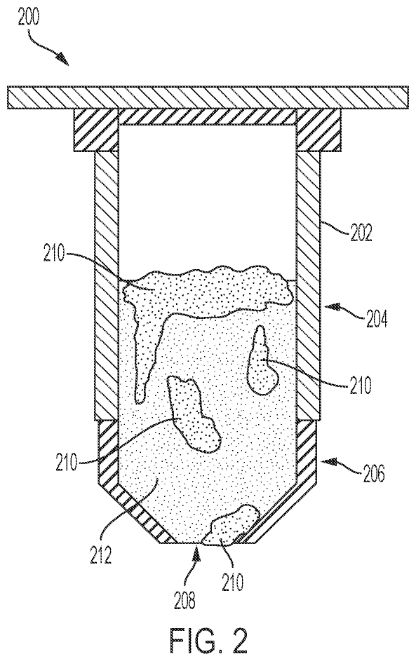

FIG. 2 is a side cross-sectional views of a liquid ejector jet contaminated with dross, in accordance with the present disclosure. The ejector 200 is shown, which further defines a cavity or outer wall 202 of the ejector, an upper pump area 204, a lower pump area 206, and an outlet nozzle 208. Within the inner cavity 202 of the ejector 200 is further shown a molten printing material 212 and schematic of dross 210 build-up within and on top of the printing material 212. The dross 210, in certain examples, and dependent upon which printing material is used in the printing system, is a combination of aluminum oxides, magnesium oxides, and silicates. The dross 210 may also include gas bubbles. In certain examples, the dross 210, may include additional materials or contaminants, such as oxides and silicates of aluminum (Al), calcium (Ca), magnesium (Mg), silicon (Si), iron (Fe), or possibly other contaminants containing sodium (Na), potassium (K), sulfur (S), chlorine (Cl), carbon (C) or combinations thereof, The dross 210 typically builds towards the top of the melt pool that resides near the upper pump area 204 in the ejector 200 and may potentially cause issues during printing. Dross 210 accumulation may potentially impact the ability of the aforementioned level sensor that measures the molten metal level inside the ejector 200. An erroneous signal for the level sensor system can cause the pump to empty during printing, which could result in ruining the part being printed. One or more dross 210 “plugs” may also have a propensity to grow within the pump, which in turn may cause issues with the pump dynamics. Interruptions or issues in pump dynamics may further result in poor jet quality and the formation of satellite drops during printing. A satellite drop may refer to a drop with only a fraction of the volume of the main drop which can be unintentionally formed during the jetting of a main drop. For example, a physical occlusion at the nozzle is one potential cause resulting in the formation of a satellite drop. In certain examples or instances, the dross 210 could also potentially break apart, and a portion of this fragmented dross or oxide may fall into the nozzle 208 resulting in a clogged nozzle 208. Any failure arising from the accumulation of dross 210 has the tendency to be catastrophic, which could lead to necessitating a shut down of the printer, having to clear or remove the dross 210 plug, replacing the print nozzle, beginning start-up again, or combinations thereof.

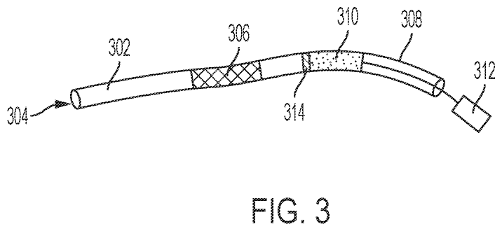

FIG. 3 is a schematic view of an end of a dross extraction device, in accordance with the present disclosure. A portion of a dross extraction system 300 includes a conduit 302 which defines a distal opening 304, also referred to as an opening away from the operator or user, which is the opening that is in communication with the external environment, and therefore a contamination targeted for removal. The internal volume of the conduit 302 only has an open connection to an external environment via the distal opening 304 and expands an enclosed volume of air to create suction. Accordingly, as atmospheric air is drawn into the internal volume, the dross enters with it. The conduit 302 further includes a filter 306 disposed therein, which may be fabricated from metal mesh, fritted glass, porous ceramic, metal wool, ceramic wool, or a combination thereof. A second portion 308 of the conduit 302 is also shown, which in certain examples may be composed of a hollow flexible tubing or other material. It should be noted that this second portion 308 of the conduit need not be as temperature resistant as the conduit 302 portion towards the distal opening 304, as it would not be in direct contact with a molten printing material. The conduit 302 also includes a piston 310 towards the second portion 308 of the conduit and further includes a seal 314 to preserve the airtight nature of the entire conduit 302. As shown, the filter 306 is located within the conduit 302 between the piston 310 and the distal opening 304. However, in alternate examples, the internal components of the conduit 302 may be arranged differently as long as the function of the dross extraction system 300 is preserved. The dross extraction system 300 also includes an actuator 312, which may be manually operated, or otherwise motorized, automated, connected to a stepper motor, servo motor, or other such automated actuation component or actuator 312. An advantage of a stepper or servo motors may be to remove only a specific amount of dross or contamination from an ejector pump consistent with an actuation distance of the actuator 312, i.e., how far a piston 310 may travel or be translated within the conduit 302, or how much compression would be changed in the instance of a compressible member used within a dross extraction system 300. Any elements of the dross extraction system 300 would necessarily be inert in contact with the liquid printing material, temperature resistant, and may include one or more textured external surfaces, useful for physically attracting dross to the conduit 302. One or more of the components of the dross extraction system 300 may be fabricated of a ceramic material, such as boron, alumina, zirconia, or ceramic-coated aluminum, and should be thermally stable at a temperature above 1000° C. Metal or metallic components having high temperature stability such as stainless steel, titanium, tungsten carbide, and the like, may also be suitable. An inert or cooling gas source may be used in conjunction with the dross extraction system 300 to enable cooling of the localized area around the dross such that the contamination may further solidify and thus be easier to extract. The position or distance that the internal piston may travel may correspond to a minimum volume point and a maximum volume point within the internal volume of the conduit. In other aspects, a compression state, i.e. compressed or not compressed, of an internal compressible member may correspond to a minimum volume point and a maximum volume point within the internal volume of the conduit. Useful internal compressible members for use in a dross extraction system 300 may include a bulb, bladder, or other compressible member made with a compressible, flexible material such as silicone, polyurethane, natural rubber or other suitable material. Alternate inserts or mechanisms within the conduit 302 that serve to increase a volume inside the extraction system enclosure, removal nozzle, or conduit of the dross extraction system may be used as well. Some examples of exemplary dross extraction systems include a cooling element disposed on an outer portion of the conduit 302, which may be gas-cooled, fluid-cooled, or refrigerant-cooled.

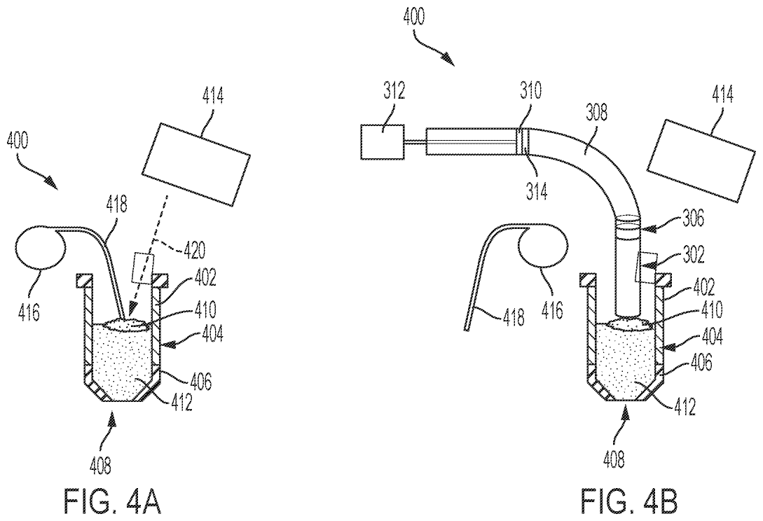

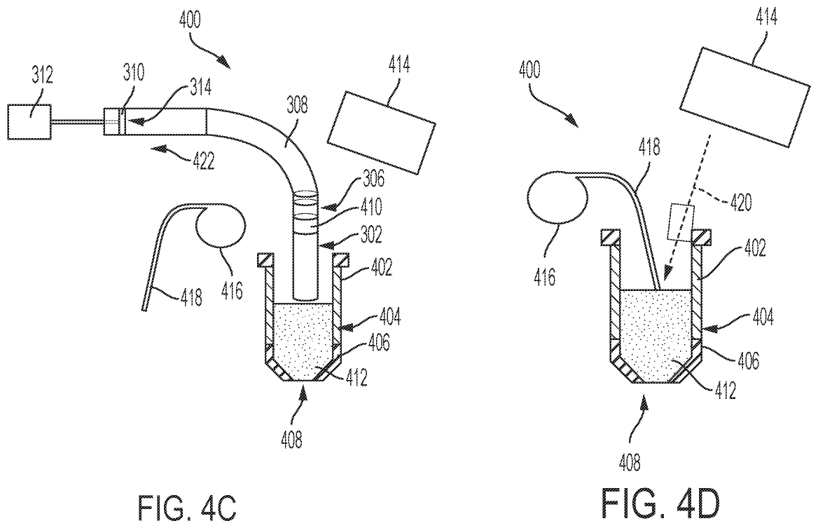

FIGS. 4A-4D are a series of side cross-sectional views of a single liquid ejector jet having a dross extraction system, illustrating operative steps of the dross extraction system, in accordance with the present disclosure. FIG. 4A is a side cross-sectional view of a print head ejector or single liquid ejector jet, similar to the one illustrated in FIG. 1, with a dross extraction system, in accordance with the present disclosure. A liquid ejector jet with a dross extraction system 400 is shown, having a printing material supply 416 with a wire feed of printing material 418 shown external to an ejector 402. Certain examples may have the printing material supply 416 located internal to a housing that includes the ejector 402. Furthermore, alternate examples may include other means of introduction of printing material, such as a powder feed system or other printing material introduction means known to those skilled in the art. Example printing materials which could be ejected using a liquid ejector according to examples described herein also include alloys of aluminum, copper, iron, nickel, brasses, naval brass, and bronzes. Silver and alloys thereof, copper and alloys thereof, metallic alloys, braze alloys, or combinations thereof may also be printed using liquid ejectors according to exemplary examples described herein. The ejector jet with a dross extraction system 400 of FIG. 4A is shown in open form, allowing access to an inner ejector 402 cavity for the printing material 418 to be introduced therein, where it may be heated to form a molten printing material 412. Other examples of such a system may include additional covers over the ejector jet 402, and said covers having an inlet coupled to the inner cavity, but it is shown in this manner for purposes of clarity. The ejector jet with a dross extraction system 400 further defines an upper pump area 404, a lower pump area 406, and a nozzle 408 of the liquid ejector jet 402. Within the ejector jet with a dross extraction system 400 is shown a quantity of molten printing material 412. The ejector jet with a dross extraction system 400 also includes an external level sensing system 414, whereby a laser 420 of the level sensing system 414 is directed towards a surface of the melt pool held within the inner cavity of the ejector 402 to measure a level of molten printing material 412 in the ejector jet 402 prior to and during print operations. Also shown is an accumulation of dross 410 inside the inner cavity of the ejector jet 402 on a top surface of the melt pool of molten printing material 412.

FIG. 4B illustrates a cross-sectional schematic of the ejector jet with a dross extraction system 400 having an accumulation of dross 410 inside the inner cavity of the ejector jet 402. The introduction of the conduit 302 of the dross extraction system 300 into the inner cavity of the ejector jet 402 and removal of the dross 410 may be periodically performed in-situ during the building of a part or other operation of the printing system 400. At a point of sufficient dross 410 accumulation, or at the point of a predetermined service interval, the printer may intermittently pause during to accommodate the dross 410 extraction operation. Prior to the introduction of the conduit 302 into the ejector 402, a measurement device may perform a baseline measurement of the melt pool or other system parameters, for example to determine a level of molten printing material 412 within the ejector jet 402. Furthermore, at this point, an inert gas may be introduced near the top portion or upper pump area 404 of the ejector jet 402. The conduit 302 of the dross extraction system 300 is raised and lowered to insert the conduit 302 into the ejector jet 402 where the distal opening 304 of the conduit 302 may be submerged approximately 4-5 mm into the molten printing material 412, although other depths may be used depending on the amount of dross 410 accumulated in the system. Once the conduit 302 is lowered into the upper pump area 404 as shown, the distal opening 304 of the conduit 302 remains near or at the top of the melt pool of molten printing material 412 as does the accumulated dross 410, due to its density, thereby allowing the dross 410 to adhere to and be drawn near the distal opening 304 of the conduit 302 of the dross extraction system 300. At this time, the conduit 302 or a portion thereof may or may not be rotating in order to facilitate dross 410 adherence to and extraction by the conduit 302. The rotation or movement may enable the dross extraction system 300 to help enable dross fragments be brought into or near the distal opening 304 of the conduit 302. The movement also maximizes surface contact between the dross extraction system 300 conduit 302 and dross 410. At this stage, the actuator 312, the piston 310 and the seal 314 are in an initial position or located closer to the conduit 302 portion of the dross extraction system 300. The second portion 308 of the conduit, which may be flexible is shown to be bent at an approximate 90-degree angle to move some of the dross extraction system 300 away from the ejector jet 402. The space or volume within the conduit 302 between the distal opening 304 and the filter 306 is indicative of the volume of dross that may be extracted in a single extraction step using the dross extraction system 300. The filter 306 is disposed in an internal volume of the conduit 302 and positioned away from the distal opening 304 of the conduit 302, the space between the filter 306 and the distal opening 304 of the conduit 302 is configured to hold a volume of dross. The conduit 302, which is external to the ejector is positionable to contact the liquid printing material to attract dross therein, thereby extracting dross from the liquid printing material when a negative pressure is introduced between an internal volume of the conduit and the dross. In some aspects, the conduit 302 may include an internal compressible member, where an internal volume is subjected to a change in pressure when the internal compressible member changes from a compressed state to an uncompressed state. Dross extraction systems having such an internal mechanism may avoid the use of a vacuum source or a valved mechanism. By creating a negative pressure within the dross extraction system, this enables the use of a device having a limited or short stroke which can provide improved control over volume of dross extracted. Better control over suction as compared to other known methods utilizing valves, vacuum, or the combination thereof provides a discrete amount of suction applied within the dross extraction system. Based on the location of the internal piston at the setting or position point, finite control over how much air or volume of air is drawn into the device may be gained. This value may be based on a volume of ink throughput at the time of extraction, which can be used to set the interval of extraction operations as well. In certain examples, two positions of an internal piston, internal compressible member, or other device capable of influencing a minimum volume and maximum volume of air or space within the extraction system. Additionally, a motor, for example, a stepper motor, may be used to control a minimum volume point, a maximum volume point, or a speed at which the piston or other actuation device moves or translates.

FIG. 4C illustrates the dross extraction system 300 being removed or extracted from the inner cavity of the ejector jet 402, once the actuator 312 and therefore the piston 310 and the seal 314 have been translated to a second position in a direction 422, as compared to the position depicted in FIG. 4B. When the internal piston 310 translates along a length of the conduit, an internal volume of the conduit 302 is subjected to a change in pressure. By actuating the piston 310 in such a manner, a negative pressure, or suction has been created within an internal volume of the conduit 302, and therefore suctions or draws the dross 410 into the conduit 302. For example, the internal piston 310 creates suction within an internal volume of the conduit 302 when the piston 310 is translated away from the distal opening 304. In the example shown in FIG. 4C, the printing material supply 416 and the printing material 418 would be removed prior to the introduction of the dross extraction system 300 into the ejector jet 402. Once the dross extraction system 300 with the accumulated dross 410 is removed from the inner cavity, the dross extraction system 300 may be removed from the ejector jet 402 and the ejector jet system with dross extraction system 400. The dross 410 is now held within the conduit 302 of the dross extraction system 300 as the conduit 302 is retracted back out of the ejector cavity of the ejector jet 402. As the dross 410 is being removed, a gas source, not shown here, may be used to deliver a regulated flow of an inert gas to the environment in or around the conduit 302 to cool extracted dross 410 and increase its solidification within the dross extraction system 300 to prevent further reaction with atmospheric gases as the dross is extracted from the ejector cavity. The gas further may provide a small amount of cooling to the liquid metal held in the conduit 302 preventing the molten metal from dripping out of the conduit 302 and back into the ejector jet 402.

FIG. 4D illustrates a step in the dross extraction showing the dross 410, now removed from the ejector jet 402 after the dross extraction system 300 is retracted back out of the inner cavity of the ejector jet 402. At this stage, the printing material 418 may be fed back into the inner cavity of the ejector jet 402 and printing operations or part build can be resumed. Thus, the dross extraction can occur during the part print job and the print job can continue once the dross is removed from the system. It should be noted that alternate examples or aspects of a dross extraction system for a liquid metal ejector may include alternate means of introducing the extraction system into an ejector jet to remove accumulated dross. This may include manual introduction and removal of a probe into and out from an ejector jet, such by an operator or by means that is automated, motor configured to control a position of the internal piston along the length of the conduit. Motor control may change a compression state of the internal compressible member or a translation position of an internal piston. The actuator may be driven manually or by software, or by a computer or computer program. Advantages of such an in-process dross extraction system include higher printing throughput, reduced downtime for cleaning or catastrophic failures related to dross accumulation, extended print run time, larger part builds, and increased printing system productivity. Additional system advantages include improved jetting performance, improved measurement, and control of the level of the melt pool inside the ejector jet, enablement of printing system running at higher pump temperatures for improved jet quality, and improved component life, particularly the life of the upper pump of the ejector.

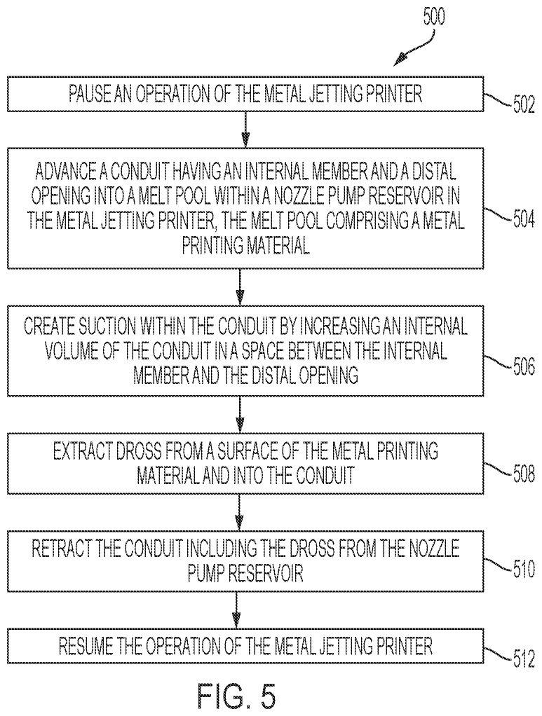

FIG. 5 is a flowchart illustrating a method of extracting dross in a metal jetting printer, in accordance with the present disclosure. The method of extracting dross from a metal jetting printer 500, begins with a step to pause an operation of the metal jetting printer 502. Next, a conduit having an internal member and a distal opening is advanced into a melt pool within a nozzle pump reservoir in the metal jetting printer, where the melt pool comprising a metal printing material 504. Suction is created within the conduit by increasing an internal volume of the conduit in a space between the internal member and the distal opening 506 and dross is extracted from a surface of the metal printing material and into the conduit 508. The conduit is then retracted, including the dross from the nozzle pump reservoir 510, and the operation of the metal jetting printer is resumed 512. In addition to any of the noted arrangements or features of the conduit, the internal member may include a piston, or alternatively a compressible member. It should be noted that any of the method steps may be repeated, either in sequence or individually during an operation to remove a dross contamination from an ejector within a printer system. It should further be noted that one or more examples provided in the present disclosure may also be used in the context of the present methods as described.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A dross extraction system for a printer, comprising:
a conduit external to an ejector having a distal opening, positionable to contact a liquid printing material to attract dross therein, thereby extracting dross from the liquid printing material when a negative pressure is introduced between an internal volume of the conduit and the dross.

2. The dross extraction system for a printer of claim 1, wherein the conduit further comprises a filter disposed in an internal volume of the conduit and positioned away from the distal opening of the conduit, wherein a space between the filter and the distal opening of the conduit is configured to hold a volume of dross.

3. The dross extraction system for a printer of claim 2, wherein the filter comprises a temperature resistant material.

4. The dross extraction system for a printer of claim 2, wherein the filter comprises a porous ceramic.

5. The dross extraction system for a printer of claim 1, wherein the conduit further comprises a temperature resistant material.

6. The dross extraction system for a printer of claim 1, wherein the conduit further comprises a ceramic.

7. The dross extraction system for a printer of claim 1, wherein the conduit further comprises an internal piston, wherein when the internal piston translates along a length of the conduit, the internal volume of the conduit is subjected to a change in pressure.

8. The dross extraction system for a printer of claim 7, wherein the internal piston creates suction within an internal volume of the conduit when the piston is translated away from the distal opening.

9. The dross extraction system for a printer of claim 1, wherein the conduit further comprises an internal compressible member, wherein an internal volume is subjected to a change in pressure when the internal compressible member changes from a compressed state to an uncompressed state.

10. The dross extraction system for a printer of claim 1, wherein the conduit further comprises an internal compressible member, wherein an internal volume is subjected to a change in pressure when the internal compressible member changes from an uncompressed state to a compressed state.

11. The dross extraction system for a printer of claim 1, wherein the dross extraction system comprises no vacuum source.

12. The dross extraction system for a printer of claim 1, wherein the dross extraction system comprises no valve.

13. The dross extraction system for a printer of claim 1, further comprising a cooling element disposed on an outer portion of the conduit.

14. A printer, comprising:
an ejector defining an inner cavity associated therewith, the inner cavity retaining a liquid printing material;
a first inlet coupled to the inner cavity; and
a dross extraction system, comprising:
a conduit external to the ejector; wherein
the conduit comprises a distal opening and is configured to contact the liquid printing material to attract dross therein;
is configured to be advanced into and retracted out from the inner cavity of the ejector; and
a filter disposed in an internal volume of the conduit and positioned away from the distal opening of the conduit, wherein a space between the filter and the distal opening of the conduit is configured to hold a volume of dross.

15. The printer of claim 14, wherein the conduit further comprises an internal piston, wherein:
the internal piston translates along a length of the conduit when the internal volume of the conduit is subjected to a change in pressure; and
the internal piston creates suction within an internal volume of the conduit when the piston is translated away from the distal opening.

16. The printer of claim 14, wherein the conduit further comprises an internal compressible member, wherein:
an internal volume is subjected to a change in pressure when the internal compressible member changes from a compressed state to an uncompressed state; and
an internal volume is subjected to a change in pressure when the internal compressible member changes from an uncompressed state to a compressed state.

17. The printer of claim 14, wherein the internal volume of the conduit only has an open connection to an external environment via the distal opening.

18. The printer of claim 15, further comprising a motor configured to control a position of the internal piston along the length of the conduit.

19. The printer of claim 16, further comprising a motor configured to control a compression state of the internal compressible member.

20. A method of extracting dross from a metal jetting printer, comprising:
pausing an operation of the metal jetting printer;
advancing a conduit having an internal member and a distal opening into a melt pool within a nozzle pump reservoir in the metal jetting printer, the melt pool comprising a metal printing material;
creating suction within the conduit by increasing an internal volume of the conduit in a space between the internal member and the distal opening;
extracting dross from a surface of the metal printing material and into the conduit;
retracting the conduit including the dross from the nozzle pump reservoir; and
resuming the operation of the metal jetting printer.

21. The method of extracting dross from a metal jetting printer of claim 20, wherein the internal member comprises a piston.

22. The method of extracting dross from a metal jetting printer of claim 20, wherein the internal member comprises a compressible member.
